(19) United States
(12) Patent Application Publication
(10) Pub. No.: US 2026/0200086 A1
(43) Pub. Date: Jul. 16, 2026

(54) ROBOT AND CONTROL METHOD THEREOF

(71) Applicant: LG ELECTRONICS INC., Seoul (KR)

(72) Inventor: Donghoon KWAK, Seoul (KR)

(73) Assignee: LG ELECTRONICS INC., Seoul (KR)

(21) Appl. No.: 19/135,730

(22) PCT Filed: May 23, 2023
(86) PCT No.: PCT/KR2023/006981

§ 371 Date: Jun. 4, 2025

(30) Foreign Application Priority Data
Dec. 5, 2022 (KR) 10-2022-0167553

(51) Int. Cl. B25J 9/16; B25J 5/00; B25J 19/00; B62D 57/028

(52) U.S. Cl. CPC B25J 9/1666; B25J 5/007; B25J 9/1697; B25J 19/005; B62D 57/028

(57) ABSTRACT

There is disclosed a robot including a robot body that accommodates a battery; two wheels disposed in a lower portion of the robot body; two leg units connected between the robot body and the wheels; an arm having an integrated structure including a pair of rotational coupling portions disposed on left and right sides, respectively, to be rotatably coupled to the robot body, and a connecting portion connecting the pair of rotational coupling portions to each other; and a sensor unit configured to detect a driving obstacle positioned in a driving path of the wheels, and when the sensor unit detects the driving obstacle, a preset response motion may be performed and the response motion may include a rotation motion of the arm.

### BACKGROUND

### Technical Field

Embodiments of the present disclosure relate to a robot and a control method of the same, more particularly, a robot that may provide various services based on commands input by a user.

### Background of the Disclosure

Recently, with advancement of robot technology, the use of robots is increasing not only in the industrial field but also in the home.

Home robots include robots that perform tasks inside the home such as helping with housework like cleaning or controlling electric hole appliances, robots that use artificial intelligence AI to act as secretaries or provide education to users, or robots that replace pets.

There exist not only as robots that preform their functions while remaining fixed in a specific location but also mobile robots that can move. In particular, for robots used in the home mobile robots that can move around the housing on behalf of the user or follow the user are mainly used.

Among mobile robots, two-wheeled robots have the advantage of being easy to store as they occupy a small area of land, and the advantage of being easy to use in the home with relatively narrow spaces as they have a small turning radius when changing direction.

Despite these advantages, two-wheeled robots may encounter the following problems.

Since the two-wheeled robots are usually connected to wheels and a robot body through long legs that extend vertically, they have a structure in which the vertical height is high compared to the forward-backward length and the left-right length. When a two-wheeled robot with this structure encounters an obstacle that impedes driving while driving on the ground, the following problems may occur.

First, it may be difficult for the two-wheeled robot to pass through obstacles that are open at the bottom and blocked at the top, such as tables and desks. The two-wheeled robot may be able to control its driving to avoid or turn around such upper obstacles, but if the two-wheeled robot's driving path is limited in this way, there is a possibility that the two-wheeled robot will not reach the desired destination, and driving is not only inefficient, but is also not desirable for expanding the robot's functions.

Second, when trying to avoid by turning the wheel in the opposite direction, the robot may tilt in the original direction due to inertia and fall over. A sudden fall may cause damage to various sensors installed in the robot body. In the worst case, the robot may roll down a cliff.

As Cited document 1, Korean Patent Publication No. 2018-0094697 is disclosed.

Cited document 1 discloses a cleaner including a cleaner body, a wheel unit including a wheel that supports the cleaner body to be movable relative to the floor, and a suspension unit in which the wheel unit is installed to be movable up and down and absorbs shock when the wheel unit moves up and down.

The cleaner includes a lifting unit that is coupled to the cleaner body and raises the cleaner body, thereby raising the height of the cleaner body, preventing carpet hairs from being sucked into the suction port on the bottom of the cleaner and maintaining the driving performance of the cleaner.

Cited document 1 is not a form in which the wheels and the robot body are connected through long legs extended vertically. In other words, unlike a two-wheeled robot, it does not have a leg with a joint structure, so the height is low compared to the front, back, left, and right length, so there is no problem of not being able to pass through an upper obstacle such as a table, and even if the direction is changed abruptly around a cliff, the center of gravity is low, so there is no problem of falling over.

As Cited document 2, Korean Patent Publication No. 2021-0064016 is disclosed.

Cited document 2 is characterized in a driving module of an autonomous driving robot, wherein the driving module comprises a first wheel that is constantly in contact with the ground or a road surface and has a first rotation axis, a second wheel and a third wheel whose positions are constrained relative to each other, a rear bar having a second rotation axis of the second wheel at one end, an upper shaft part at the other end, and an intermediate shaft part in the middle, a front bar having a third rotation axis of the third wheel at one end and a rotatably connected to the intermediate shaft part at the other end, and a suspension part having one end rotatably connected to the upper shaft part and the other end rotatably connected to the third rotation axis or the front bar.

The driving module can lift the autonomous driving module higher through a link frame structure that enables the front and rear bars to swing/seesaw, and thus has the effect of easily overcoming driving obstacles or structures such as stairs or bumps located on the ground or road surface.

Cited document 2 has a structure that runs on three sets of wheels (a total of six wheels). In other words, it is a structure in which the center of gravity is distributed over a number of wheels, so even if the direction is changed abruptly around a cliff, there is no problem of falling over.

In other words, the above-mentioned prior documents have a different structure from a two-wheeled robot configured to drive with two wheels and have a leg section of a joint structure extending in the vertical direction, and therefore do not share the problems and tasks to be solved that are unique to two-wheeled robots.

### DETAILED DESCRIPTION OF THE INVENTION

### Technical Problem

Accordingly, one object of the present disclosure is to solve the above-noted disadvantages of the prior art, and to provide a robot that may perform appropriate response motion when there is an upper obstacle ahead of the driving direction.

Another object of the present disclosure is to provide a robot that may perform appropriate response motion when there is a cliff ahead of the driving direction.

### Technical Solution

To solve the above objects, a robot according to one embodiment may include a robot body that accommodates a battery; two wheels disposed in a lower portion of the robot body; two leg units connected between the robot body and the wheels; an arm having an integrated structure including a pair of rotational coupling portions disposed on left and right sides, respectively, to be rotatably coupled to the robot body, and a connecting portion connecting the pair of rotational coupling portions to each other; and a sensor unit configured to detect a driving obstacle positioned in a driving path of the wheels.

In the embodiment of the robot, each of the leg units may include an upper link linked to the robot body; and a lower link linked to the wheels.

In the embodiment of the robot, the sensor unit may include a depth camera.

In the embodiment of the robot, the sensor unit may include a cliff sensor.

At this time, in the embodiment of the robot, when the sensor unit detects a driving obstacle, a preset response motion may be performed.

The response motion may include a rotation motion of the arm.

In the embodiment of the robot, if the driving obstacle is an upper obstacle existing in an upper area in front of the driving direction of the wheels, the response motion may determine whether to pass or avoid the upper obstacle by measuring the height from the ground to a lower end of the upper obstacle.

The response motion may rotate the arm so that an upper end of the arm is positioned lower than an upper end of the robot body, but the rotation direction of the arm may be opposite to the driving direction of the robot.

The response motion at this time may reduce the coupling angle between the upper link and the lower link so that the robot body can move toward the ground.

In the embodiment of the robot, if the driving obstacle is a cliff existing in a lower area in front of the driving direction of the wheels, and when the depth camera detects the existence of the cliff, if the distance to the cliff approaches to a preset distance or less, the response motion may decelerate the rotation speed of the wheels.

In addition, the response motion at this time may include a motion that changes the rotation direction of the wheel to the opposite direction when the cliff sensor detects the presence of the cliff.

In addition, the response motion at this time may first rotate the arm before changing the rotation direction of the wheel, and the rotation direction of the arm may be the driving direction of the robot.

In addition, the response motion at this time may rotate until the lower end of the arm is disposed in a front lower portion of the robot body.

According to another embodiment of the present disclosure, as a control method performed for a robot driving on the ground using two wheels to pass an upper obstacle existing in front of the driving direction, a control method of a robot may include a sensing step in which a sensor unit of the robot detects the upper obstacle; an arm rotation step in which an arm having an integrated structure coupled to left and right sides of a robot body of the robot is rotated to be positioned lower than an upper end of the robot body; and a leg control step in which a coupling angle of a leg unit connecting the robot body and the wheel is controlled so that the robot body comes closer to the ground.

At this time, the arm rotation step may rotate the arm in the opposite direction to the driving direction of the robot.

The sensing step may measure a first height from the ground to a lower end of the upper obstacle by using the sensor unit, and compare the first height with a second height which is the minimum height of the robot implemented through the control of the arm and the leg unit and determines passage or avoidance of the upper obstacle.

According to a further embodiment of the present disclosure, as a control method preformed for a robot driving on the ground using two wheels to avoid a cliff existing in front of the driving direction, a control method of a robot may include a first detection step in which a depth camera provided in the robot detects the cliff; a first motion step in which an arm having an integrated structure coupled to left and right sides of a robot body of the robot rotates in the driving direction of wheels; a second detection step in which a cliff sensor provided in the robot detects the cliff, and a second motion step in which the rotation direction of the wheels is changed so that the robot drives in the opposite direction of the cliff.

The first motion step may decelerate the rotation speed of the wheels when the distance to the cliff approaches a preset distance or less.

The first motion step may dispose a lower end of the arm in a lower front portion of the robot body.

### Advantageous Effects

According to the embodiments, when there is an upper obstacle ahead of the driving direction, the robot may pass through the upper obstacle without changing the driving path by performing a corresponding motion to lower the overall height of the robot by controlling the arm and leg parts.

Furthermore, according to the embodiments, when there is a cliff ahead of the driving direction, the robot may perform the response motion of rotating the arm in advance and placing it at the lower front side of the robot body, thereby preventing the robot from falling over even if the robot suddenly changes the driving direction around the cliff and the center of gravity tilts.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### DESCRIPTION OF DRAWINGS

FIG. 1 is a perspective view to describe a robot according to one embodiment of the present disclosure;

FIG. 2 is a front view of a robot according to one embodiment of the present disclosure;

FIG. 3 is a perspective view of a robot according to one embodiment of the present invention, viewed from different angles;

FIG. 4 is a partially cut-away view to describe power transmission for rotating an arm in a robot according to one embodiment of the present disclosure;

FIG. 5 is a plane view of a robot according to one embodiment of the present disclosure;

FIG. 6 is a view to describe an arm of a robot according to another embodiment of the present disclosure;

FIG. 7 is a view to describe a state where a detachable portion of the arm shown in FIG. 6 is rotated;

FIG. 8 is a bottom view of a robot according to one embodiment of the present disclosure;

FIG. 9 is a block view to describe control configurations of a robot according to one embodiment of the present disclosure;

FIG. 10 is a view to describe a coupling relationship between a robot mask and a robot body in a robot according to one embodiment of the present disclosure;

FIG. 11 is a flow chart showing a control method of a robot that is performed to respond to an upper obstacle existing ahead in a driving direction;

FIGS. 12 to 17 sequentially showing a response motion of the robot performed in the embodiment of FIG. 11;

FIG. 18 is a flow chart showing a control method of a robot that is performed to respond to a cliff existing ahead in a driving direction; and

FIGS. 19 to 21 sequentially showing a response motion of the robot performed in the embodiment of FIG. 18.

### DESCRIPTION OF SPECIFIC EMBODIMENTS

Referring to the accompanying drawings, embodiments of the present disclosure will be described in detail.

Description will now be given in detail according to exemplary embodiments disclosed herein, with reference to the accompanying drawings. For the sake of brief description with reference to the drawings, the same or equivalent components may be provided with the same reference numbers, and description thereof will not be repeated.

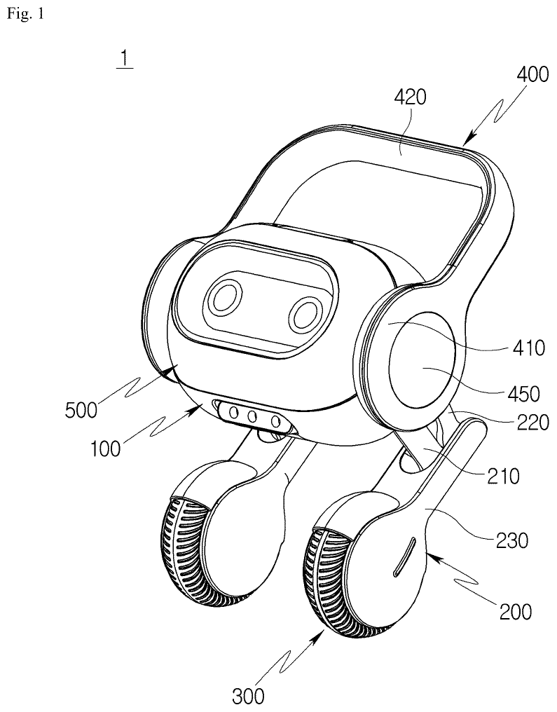

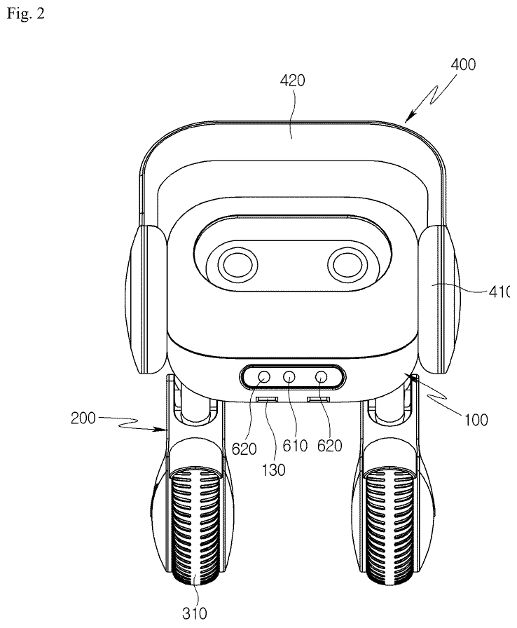

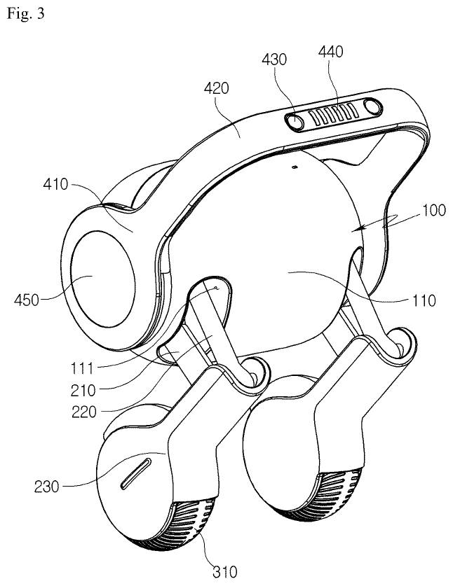

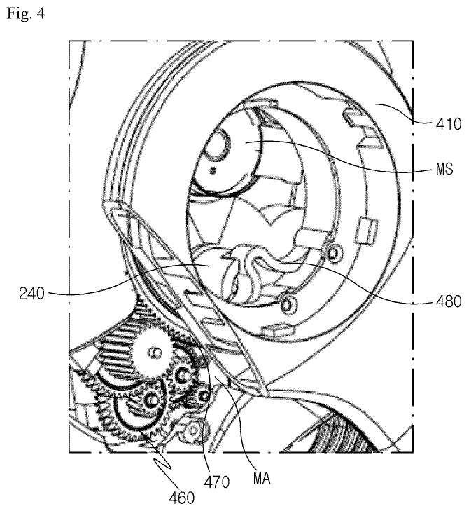

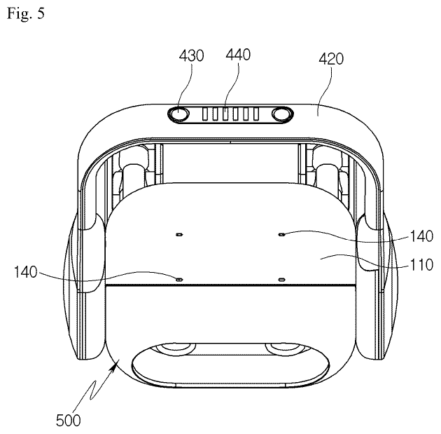

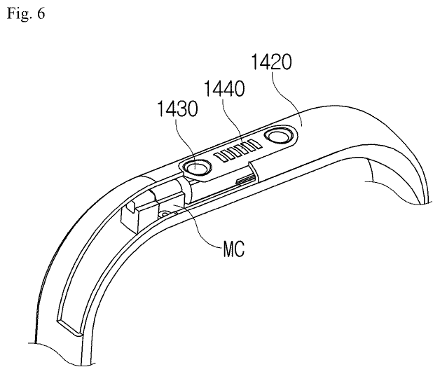

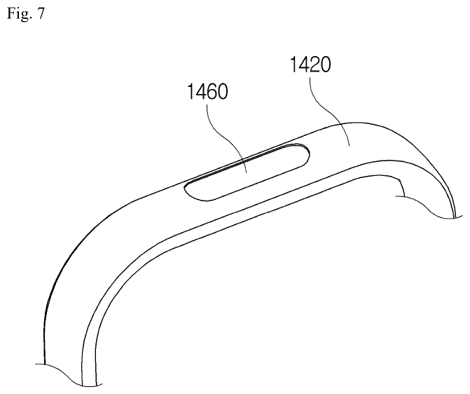

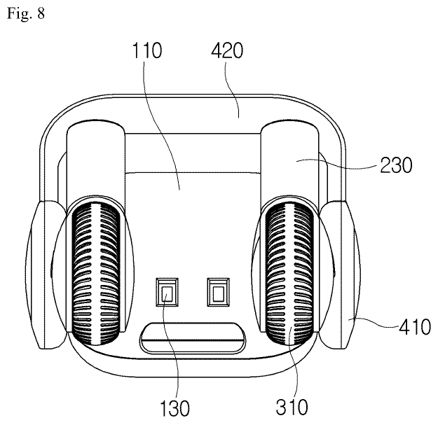

FIG. 1 is a perspective view to describe a robot according to one embodiment of the present disclosure. FIG. 2 is a front view of a robot according to one embodiment of the present disclosure. FIG. 3 is a perspective view of a robot according to one embodiment of the present invention, viewed from different angles. FIG. 4 is a partially cut-away view to describe power transmission for rotating an arm in a robot according to one embodiment of the present disclosure. FIG. 5 is a plane view of a robot according to one embodiment of the present disclosure. FIG. 6 is a view to describe an arm of a robot according to another embodiment of the present disclosure. FIG. 7 is a view to describe a state where a detachable portion of the arm shown in FIG. 6 is rotated. FIG. 8 is a bottom view of a robot according to one embodiment of the present disclosure.

Referring to FIGS. 1 to 8, the robot 1 according to one embodiment of the present disclosure will be described as follows.

The robot 1 according to the embodiment of the present disclosure is placed on the floor and moves along the floor surface (B). Accordingly, the following description will be made by determining the up-down direction based on the state in which the robot 1 is placed on the floor.

The direction in which a first camera 610a to be described later is placed may be set as the front direction or forward of the robot 1 and explained. In addition, the direction opposite to the front is set as the rear direction or rearward of the robot 1 and explained.

The ‘lowest portion’ of each configuration described in the embodiment of the present invention may be the portion that is positioned lowest in each configuration when the robot 1 according to the embodiment of the present invention is used while placed on the floor, or may be the portion closest to the floor.

A robot (1) according to one embodiment may include a robot body 100, a leg unit 200, a wheel unit 300, an arm 400, and a robot mask 500. At this time, the leg unit 200 is coupled to the robot body 100, and the wheel unit 300 is coupled to the leg unit 200. In addition, the arm 400 is pivotally coupled to both sides of the robot body 100. In addition, the robot mask 500 is detachably coupled to the robot body 100.

### Robot Body

Referring to FIGS. 1 to 8, the robot body 100 of the robot 1 according to one embodiment will be described as follows.

Each component of the robot 1 may be coupled to the robot body 100. For example, the robot mask 500 may be detachably coupled to the robot body 100. In addition, the arm 400 is pivotally coupled to the robot body 100. The arm 400 may be pivotally connected to both ends of the robot body 100. The robot body 100 may be configured to perform additional functions by being connected to a functional module through the arm 400. In addition, the robot body 100 may be configured to implement a standby posture for power saving or a posture for getting up after falling through the arm 400.

Some components forming the robot 1 may be accommodated inside the robot body 100.

A body housing 110 may form the outer shape of the robot body 100. The inner space of the body housing 110 may accommodate one or more motors including a suspension motor MS, one or more sensors, and a battery 800.

Also, although not shown in the drawings, at least one bumper may be provided inside the body housing 110.

The bumper may be provided to be relatively movable with respect to the body housing 110. For example, the bumper may be coupled to the body housing 110 so as to be reciprocally movable along the front-rear direction of the body housing 110.

The bumper may be coupled along some area or the entire front edge of the body housing 110. In addition, the bumper may be arranged on the inner rear side of the body housing 110.

With this configuration, when the robot 1 collides with another object or person, the bumper may absorb the shock applied to the robot body 100 and protect the robot body 100 and the components disposed inside the robot body 100.

A pair of leg units 200 may be coupled inside the robot body housing 110. The pair of leg units 200 may penetrate the robot body housing 110 and be exposed to the outside.

Specifically, a first link 210 and a second link 220 may be rotatably coupled inside the robot body housing 110. For example, a link frame (not shown) to which the first link 210 and the second link 220 are linked may be provided inside the robot body housing 110.

In addition, a suspension motor MS may be accommodated inside the robot body housing 110. For example, a suspension motor MS may be placed in a link frame (not shown). The suspension motor MS may be connected to the first link 210.

A pair of leg guide holes 111 may be formed in the robot body housing 110. For example, the pair of leg guide holes 111 may be formed in parallel along the front-rear direction of the robot body housing 110.

With this configuration, the leg unit 200 may rotate along the leg guide holes 111, and the rotational movement range of the leg unit 200 may be guided.

The robot body housing 110 may be formed in a shape in which the horizontal width (or diameter) is larger than the vertical height. For example, the robot body housing 110 may be formed in a shape similar to an ellipsoid.

Such the robot body 100 may help the robot 1 to have a stable structure and provide a structure that is advantageous for maintaining balance when the robot 1 moves (or drives).

The robot body 100 can be placed vertically above the wheel 310 to be described later. The load of the robot body 100 may be transferred to the wheel 310 through the leg unit 200, and the wheel 310 may support the leg unit 200 and the robot body 100. With this configuration, the wheel 310 may stably support the load of the robot body 100.

The robot body 100 may include a display 120. The display 120 may be mounted to the body housing 110. The display 120 may be formed in a flat shape. The display 120 may be placed at a predetermined angle with respect to the ground. For example, the display 120 may be placed at a position facing forward and upward. With this configuration, when the robot 1 approaches the user and the user looks at the robot 1, the display 120 may be made visible.

Meanwhile, the display 120 may visually transmit information about the operating status of the robot 1 to the user.

The display 120 may be formed of any one of a light emitting diode (LED), a liquid crystal display (LCD), a plasma display panel, and an organic light emitting diode (OLED).

The display 120 may display information such as operating time information of the robot 1, power information of the battery 800, etc.

According to embodiments, the display 120 may be an input unit 125. That is, the display 120 may receive a control command from a user. For example, the display 120 may be a touch screen that visually displays an operating status and receives a control command from a user.

The display 120 may display the facial expression of the robot 1. Alternatively, the display 120 may display the pupils of the robot 1. The current state of the robot 1 may be personified and expressed as an emotion through the shape of the face or the shape of the pupils displayed on the display 120. For example, when the user goes out and returns home, the display 120 may display a smiling facial expression or smiling eye shape. This provides the effect of the user feeling a sense of communication with the robot 1.

A charging terminal 130 may be arranged in the robot body housing 110. For example, the charging terminal 130 may be arranged facing the ground. As an example, the charging terminal 130 may be arranged to face the ground. As another example, the charging terminal 130 may be arranged at a predetermined angle with the ground. With this configuration, when the robot 1 is coupled with a robot charging stand (not shown), the charging terminal 130 may come into contact with a terminal provided on the robot charging stand (not shown).

The charging terminal 130 may be electrically connected to the robot charging stand (not shown). With this configuration, the robot 1 may be supplied with power through the charging terminal 130. The power supplied to the charging terminal 130 may be supplied to the battery 800. In addition, the robot 1 may receive an electric signal through the charging terminal 130. The electric signal transmitted through the charging terminal 130 may be received by the control unit 700.

Meanwhile, a first camera 610a may be placed on the front lower portion of the robot body housing 110. For example, the first camera 610a may be placed on a center line passing through the left and right centers of the robot body housing 110. With this configuration, the first camera 610a may detect an object or person placed in front of the robot 1.

In addition, an IR sensor 620 may be placed at the front lower portion of the robot body housing 110. For example, a pair of IR sensors 620 may be placed in the left and right directions at a predetermined interval. With this configuration, the IR sensor 620 may detect the position of a light source that generates infrared rays.

The IR sensor 620 may be placed close to the first camera 610a. For example, the first camera 610a may be placed between the pair of IR sensors 620.

### Leg Unit

Referring to FIGS. 1 to 8, the leg unit 200 of the robot 1 according to one embodiment of the present invention is described as follows.

The leg unit 200 is coupled to the robot body 100 and may support the robot body 100. For example, a pair of leg units 200 may be provided and are respectively coupled to the inside of the robot body housing 110. The pair of leg units 200 may be arranged symmetrically (linearly symmetrically) to each other. At this time, at least a portion of the leg units 200 is arranged closer to the ground than the robot body 100. The leg units 200 are arranged to connect the robot body 100 and the wheel 310.

Therefore, the robot body 100 may run in a form of standing on the ground by the pair of leg units 200. That is, the gravity applied to the robot body 100 may be supported by the leg units 200, and the height of the robot body 100 may be maintained.

The leg units 200 include a first link 210, a second link 220, and a third link 230. At this time, the first link 210 and the second link 220 are rotatably coupled to the robot body 100 and the third link 230, respectively. That is, the first link 210 and the second link 220 are link-coupled to the robot body 100 and the third link 230, respectively.

The first link 210 is linked to the left and right sides inside the robot body 100.

The first link 210 is connected to the suspension motor MS. For example, the first link 210 may be connected directly or through a gear to a shaft of the suspension motor MS. With this configuration, the first link 210 receives driving force from the suspension motor MS.

The first link 210 is formed in a frame shape, and the suspension motor MS is connected to one side in the longitudinal direction, and the third link 230 is coupled to the other side in the longitudinal direction. At this time, one side of the first link 210 connected to the suspension motor MS may be arranged farther from the ground than the other side coupled to the third link 230.

One side of the first link 210 is coupled to a leg support (not shown) provided inside the robot body housing 110. The first link 210 can be rotatably coupled to the leg support. For example, one side of the first link 210 may be formed in a disk shape or a circular plate shape. Accordingly, one side of the first link 210 may be connected to the suspension motor MS by penetrating the leg support.

One side of the first link 210 is connected to the suspension motor MS. For example, one side of the first link 210 may be fixedly connected to the shaft of the suspension motor MS. With this configuration, when the suspension motor MS is driven, one side of the first link 210 may rotate in conjunction with the rotation of the shaft of the suspension motor MS.

The other side of the first link 210 is rotatably connected to the third link 230. For example, a through hole may be formed in the other side of the first link 210. A shaft may be rotatably connected through the through hole. Both longitudinal ends of the shaft may be connected to the third link 230.

With this configuration, the shaft can be an axis on which the first link 210 and/or the third link 230 rotate. Therefore, the first link 210 and the third link 230 may be connected so as to be relatively rotatable.

Although not shown, the leg unit 200 may further include a gravity compensation portion. The gravity compensation portion compensates for the robot body 100 descending vertically due to gravity. In other words, the gravity compensation portion provides force to support the robot body 100.

For example, the gravity compensation portion may be a torsion spring. The gravity compensation portion may be wound to wrap around the outer surface of the first link 210. Then, one end of the gravity compensation portion may be inserted into the first link 210 and fixedly connected, and the other end of the gravity compensation portion may be inserted into the third link 230 and fixedly connected.

The gravity compensation portion applies force (rotational force) in a direction in which the angle between the first link 210 and the third link 230 increases. For example, the gravity compensation portion may have both ends of the gravity compensation portion folded in advance so as to apply a restoring force in a direction in which the angle between the first link 210 and the third link 230 increases. Accordingly, even if gravity is applied to the robot body 100 while the robot 1 is placed on the ground, the angle between the first link 210 and the third link 230 may be maintained within a predetermined angle range.

With this configuration, even if the suspension motor MS is not driven, the robot body 100 may be prevented from descending toward the ground. Therefore, there is an effect of preventing energy loss due to the suspension motor MS driving by the gravity compensation unit while maintaining the height of the robot body 100 above a predetermined distance from the ground.

The second link 220 is linked to the left and right sides inside the robot body 100. For example, the second link 220 may be linked to a leg support (not shown) provided inside the robot body housing 110. That is, the second link 220 may be linked together with the leg support (not shown) to which the first link 210 is coupled.

The second link 220 is formed in a frame shape, and one side in the longitudinal direction is coupled to a leg support member (not shown), and the other side in the longitudinal direction is coupled to the third link 230.

The second link 220 may accommodate a wire. For example, a space in which a wire can be accommodated can be formed on the inside of the second link 220. Accordingly, power from the battery 800 may be supplied to the wheel unit 300 through the wire. In addition, the wire may be prevented from being exposed to the outside.

One side of the second link 220 is rotatably coupled to the leg support member. For example, although not shown, one side of the second link 220 may be penetrated by a shaft coupled to the leg support member. A hollow space can be formed in the shaft. A wire can pass through the hollow space. With this configuration, the wires supplying power from the battery 800 to the wheel motor MW may be prevented from being exposed to the outside.

The other end of the second link 220 is rotatably coupled to the third link 230. Specifically, the other end of the second link 220 is rotatably coupled to the third link 230 through a shaft. For example, the other end of the second link 220 may be formed in a disk shape, and the shaft may be penetrated and coupled. In addition, the longitudinal ends of the shaft may be coupled to the third link 230. With this configuration, the shaft may become an axis on which the second link 220 and/or the third link 230 rotate. Accordingly, the second link 220 and the third link 230 may be connected to be relatively rotatably coupled.

The third link 230 is linked to the first link 210 and the second link 220, and is coupled to the wheel unit 300.

The third link 230 is formed in a frame shape, and the first link 210 and the second link 220 are coupled to one side in the longitudinal direction, and the wheel unit 300 is coupled to the other side in the longitudinal direction.

The third link 230 is linked to the first link 210 and the second link 220 on one side in the longitudinal direction. For example, a space may be formed on one side of the third link 230 so that the first link 210 and the second link 220 may be accommodated. That is, one side of the third link 230 may be formed in the shape of a pair of parallel frames, and the first link 210 and the second link 220 may be accommodated in the space between the pair of frames.

Here, two shafts may be arranged in parallel between a pair of frames. That is, both ends of each of the two shafts may be coupled to a pair of frames. And each of the shafts may pass through the first link 210 and the second link 220. At this time, the first link 210 may be arranged forward and lower than the second link 220. That is, the shaft passing through the first link 210 may be arranged closer to the wheel 310 than the shaft passing through the second link 220.

Therefore, the first link 210 and the second link 220 may be coupled to the third link 230 so as to be rotatable relative to each other.

The longitudinal other side of the third link 230 is coupled to the wheel unit 300. The longitudinal other side of the third link 230 may be formed to cover at least a portion of the wheel 310. For example, the longitudinal other side of the third link 230 may be formed to cover the center of rotation of the wheel 310, and a space can be formed inside to rotatably accommodate the wheel 310.

In addition, a wheel motor MW may be accommodated inside the longitudinal other side of the third link 230.

With this configuration, the wheel 310 and the wheel motor MW may be accommodated on the longitudinal side of the third link 230, and the wheel 310 may be rotatably coupled.

Meanwhile, a sensor configured to measure a distance from the ground may be provided on the longitudinal side of the third link 230. For example, the sensor can be a ToF sensor (Time of Flight sensor). With this configuration, the control unit 700 may determine whether the wheel 310 is in contact with the ground.

Meanwhile, a stopper 240 may be provided in the leg unit 200. The stopper 240 may be placed inside the robot body housing 110. The stopper 240 may be placed adjacent to the rotational coupling portion 410 of the arm 400. For example, the stopper 240 may be placed inside the inner surface of the rotational coupling portion 410 formed in a cylindrical shape.

As an example, the stopper 240 may be placed in the leg support portion (not shown). As another example, the stopper 240 may be placed in the first link 210.

The stopper 240 may be formed in a protruding shape toward the rotational coupling portion 410. For example, the stopper 240 may be formed in a protruding shape in an arch shape that has a predetermined thickness and is arranged in a concentric circle. At this time, the outer surface of the stopper 240 may be arranged toward the upper front side of the robot 1, and the inner surface of the stopper 240 may be arranged toward the lower rear side of the stopper.

The stopper 240 may be supported by contact a rotational protrusion 480 of the arm 400 to be described later. For example, the rotational protrusion 480 that is protrudingly formed on the inner surface of the rotational coupling portion 410 may be rotated together with the rotation of the arm 400, and may be brought into contact with the rotational protrusion 480 when the arm 400 is rotated to a predetermined position.

With this configuration, the stopper 240 may limit the rotation angle of the arm 400 when the arm 400 rotates.

Looking at the balance by the leg unit 200 as a whole, the first link 210 and the second link 220 are rotatably connected to the link frame (not shown) provided inside the robot body 100, and the first link 210 and the second link 220 are linked to the third link 230. That is, the robot 1 has a structure that supports the robot body 100 through a four-section link consisting of the link frame (not shown), the first link 210, the second link 220, and the third link 230.

In addition, the leg unit 200 generates a restoring force in the direction in which the gravity compensation part lifts the robot body 100. Accordingly, even when the suspension motor MS is not driven, the pair of leg units 200 may maintain the robot body 100 raised to a predetermined height from the ground.

Meanwhile, the robot 1 according to the embodiment of the present disclosure may maintain balance by driving the suspension motor MS when lifting one of the pair of wheels 310 to overcome an obstacle or lowering the height of the robot body 100 for charging, etc.

When the suspension motor MS is driven, the first link 210 rotates around the one end adjacent to the suspension motor MS as an axis, and the other end moves upward. Then, the third link 230 connected to the other end of the first link 210 moves according to the rotation of the first link 210. Then, the second link 220 is pushed by the third link 230 and rotates. As a result, one end of the third link 230 (the point of connection with the first link 210) may move backward, and the other end of the third link 230 may move upward.

With this configuration, even if the wheel 310 is moved up and down, the range of movement in the forward and backward directions of the wheel 310 may be limited. Therefore, the robot 1 may stably maintain balance.

Therefore, the robot 1 of the present disclosure may have an effect of being able to overcome obstacles of various heights by using a four-section link structure.

### Wheel Unit

Referring FIGS. 1 to 8, the wheel unit 300 of the robot 1 according to one embodiment of the present disclosure is described as follows.

The wheel unit 300 is rotatably connected to the leg unit 200 and may roll on the ground to move the robot body 100 and the leg unit 200.

The wheel unit 300 includes the wheel 310 that contacts the ground and rolls on the ground.

The wheel 310 is provided to have a predetermined radius and is provided to have a predetermined width along the axial direction. When looking at the robot 1 from the front, at least a portion of the robot body 100 and the leg unit 200 may be arranged vertically above the wheel 310.

Although not shown, the wheel 310 may include a wheel frame formed in a circular shape. The wheel frame may be formed in a cylindrical shape with one side facing the shaft of the wheel motor MW open. Through this, the weight of the wheel frame may be reduced.

However, when the wheel frame is formed in a cylindrical shape, the overall rigidity of the wheel frame may be reduced. Considering this, ribs (not shown) for reinforcing rigidity may be formed on the inner and outer surfaces of the wheel frame, respectively.

A tire is attached to the outer surface of the wheel frame. The tire may be formed in an annular shape having a diameter that can be fitted to the outer surface of the wheel frame.

A predetermined pattern of grooves may be formed on the outer surface of the tire to improve the ground contact of the tire.

In one embodiment, the tire may be formed of an elastic rubber material.

The wheel motor MW may provide driving force to the wheel 310. The wheel motor MW may receive power from the battery 800 and generate rotational force.

The wheel motor MW may be accommodated inside the other side of the third link 230. In addition, the shaft of the wheel motor MW may be coupled to the wheel 310. That is, the wheel motor MW may be an in-wheel motor.

With this configuration, when the wheel motor MW is driven, the wheel 310 may rotate and roll along the ground, and the robot 1 may move along the ground.

### Arm

Referring to FIGS. 1 to 8, the arm 400 of the robot 1 according to one embodiment of the present disclosure is described as follows.

The arm 400 may be pivotally coupled to both sides of the robot body 100. For example, the arm 400 may mean a rotating body that is coupled to both ends of the axial direction (length direction) of the robot body 100 in the shape of an ellipsoid, and rotates around the both ends of the axial direction of the robot body 100 as one rotation axis.

Specifically, the arm 400 includes a rotational coupling portion 410, a connecting portion 420, a detachable portion 430, and a connection terminal 440.

The rotation coupling portion 410 may be rotatably coupled to both sides of the robot body 100. The rotation coupling portion 410 is provided in pairs and can be coupled to both left and right sides of the robot body 100 so as to be relatively rotatably coupled. At this time, the pair of rotation coupling portions 410 may rotate in conjunction with each other. That is, the pair of rotation coupling portions 410 rotate simultaneously with each other, and the angular size of the rotation may be the same. However, when viewed based on the robot body 100, the rotation directions of the pair of rotation coupling portions 410 may be opposite to each other. That is, when viewed based on the robot body 100, when the rotation coupling portion 410 on one side rotates clockwise, the rotation coupling portion 410 on the other side may rotate counterclockwise.

The rotational coupling portion 410 may be formed in a shape that may cover both left and right end portions of the robot body 100. For example, the rotational coupling portion 410 may be formed in a cylindrical shape having a predetermined thickness. At this time, the left and right end portions of the robot body 100 may be arranged to face each other and the rotational center of the rotational coupling portion 410.

That is, when explaining the state in which the rotational coupling portion 410 is coupled to the robot body 100, assuming that the robot body 100 is a human face, the rotational coupling portion 410 may be in a shape similar to a pair of earplugs or an earpiece of a headphone.

As shown in FIG. 4, the robot 1 according to one embodiment may have the arm motor MA placed inside the robot body housing 110. Alternatively, the arm motor MA may also be placed inside the rotation coupling portion according to embodiments.

The arm motor MA may be connected to the arm 400 to provide driving force to the arm 400. More specifically, the final output end of the shaft or gear of the arm motor MA is connected to the rotational coupling portion 410. For example, as shown in FIG. 4, the shaft of the arm motor MA may be connected to a reducer 460, and the reducer 460 may be connected to a driven gear 470.

The reducer 460 is configured of at least one gear, and transmits the rotational power applied from the arm motor MA to the driven gear 470, and may reduce the rotational speed of the driven gear 470 based on the gear ratio. Through this, the precise rotation of the arm 400 may be controlled, and the arm 400 may provide relatively large power.

The driven gear 470 may be coupled with the rotational coupling portion 410 and rotated as one. The driven gear 470 may be meshed with the output end of the reducer 460 and receive the rotational power of the arm motor MA.

With this configuration, when the arm motor MA is operated, the rotational coupling portion 410 may rotate.

The arm motors MA may be provided in two units and connected to each of the pair of rotational coupling portions 410. As another example, one arm motor MA may be provided and connected to one of the rotational coupling portions 410.

With this configuration, when the arm motors MA are operated, the pair of rotational coupling portions 410 are linked and rotated together, and the connecting portion 420 rotates together according to the rotation of the rotational coupling portion 410. That is, according to the present disclosure, the arm 400 may rotate the rotational coupling portion 410 and the connecting portion 420 as one unit with the arm shaft of the rotational coupling portion 410 as the rotational axis.

Meanwhile, a speaker 450 may be placed on the outside of the rotation coupling portion 410. That is, the speaker (450) may be placed on each of the opposite directions of the direction in which the robot body 100 is placed in the pair of rotation coupling portions 410. Accordingly, the speakers 450 may be placed at positions that cover both left and right sides of the robot body housing 110.

The speaker 450 may transmit information of the robot 1 as sound. The source of the sound transmitted by the speaker 450 may be sound data previously stored in the robot 1. For example, the previously stored sound data may be voice data of the robot 1. For example, the previously stored sound data may be a notification sound that guides the status of the robot 1. Meanwhile, the source of the sound transmitted by the speaker 450 may be sound data received through a communication unit 710.

Meanwhile, in the case of conventional robots, a pair of arms are provided on both sides of the robot body, similar to human arms, to move objects or perform specific tasks.

However, in the case where a pair of arms are provided as described above, each arm may move separately, and accordingly, the load applied to both sides of the robot maya vary. Therefore, a problem of the robot tilting to one side and falling over might occur.

In addition, when the robot falls over, the arm can attempt to stand up by touching the ground, but since the arms on both sides rotate separately to touch the ground, there is a limitation that the robot may lose its balance during the standing process and fall down again.

Meanwhile, in the case of a robot that transports an object or performs a specific task through one arm, there is a limitation that the load of the object being transported or the shock that may occur during the task may be concentrated on only one arm, which may cause damage to the arm.

To solve this, the robot 1 according to the embodiment of the present invention is configured in a form in which one arm 400 is rotatably connected to both sides of the robot body 100.

The connecting portion 420 may connect the pair of rotational coupling portions 410 to each other. The connecting portion 420 may connect the pair of rotational coupling portions 410 covering both left and right sides of the robot body 100 so that they can rotate together.

The connecting portion may connect the pair of rotational coupling portions 410 to each other and may be formed in a form that can rotate around the robot body 100. Specifically, the connecting portion 420 may be formed in a frame form in which both ends in the longitudinal direction are formed by bending and extending. At this time, the both ends of the connecting portion 420 formed by bending and extending may be arranged in parallel to each other and connected to a pair of rotational coupling portions 410. As an example, the connecting portion 420 may be formed in a ‘n’ shape. As another example, the connecting portion 420 may also be formed in an arch shape.

When explaining the state in which the arm 400 is connected to the robot body 100, assuming that the robot body 100 is a human face, the connecting portion 420 may have a shape similar to a headphone hair band. That is, assuming that the robot body 100 is a human face, the arm 400 may appear to have a shape similar to a headphone.

The connecting portion 420 may be formed integrally with a pair of rotational coupling portions 410. That is, the pair of rotational coupling portions 410 and connecting portion 420 arranged on each of the left and right sides of the robot body 100 may form an integrated arm 400.

With this configuration, the pair of rotational coupling portions 410 are connected integrally with the connecting portion 420, so that the entire arm 400 may rotate together with the rotational coupling portions 410 as the center of rotation.

Meanwhile, the rotation radius of the arm 400 may be longer than the maximum length of the first link 210 and shorter than the maximum length of the leg unit 200. Specifically, the shortest distance from the rotation center of the rotational coupling portion 410 to the outer end of the connecting portion 420 may be longer than the maximum length of the first link 210 and shorter than the maximum length of the leg unit 200.

With this configuration, when the arm 400 rotates, at least a portion of the arm 400 may be positioned closer to the ground than the first link 210.

Meanwhile, the arm 400 further includes a rotation protrusion 480 formed protruding on the inner surface of the rotational coupling portion 410.

The rotation protrusion 480 may be formed protruding on the inner surface of the rotational coupling portion 410, and may be formed in a form in which the circumferential width becomes narrower from the inner surface of the rotational coupling portion 410 toward the rotation center of the rotational coupling portion 410 (see FIG. 4).

The rotation protrusion 480 may be rotated together with the rotational coupling portion 410 and the connecting portion 420. That is, when the rotational coupling portion 410 and the connecting portion 420 are rotated, the rotation protrusion 480 is rotated by the same rotation angle as the rotational coupling portion 410 and the connecting portion 420.

The rotation protrusion 480 may be supported by making contact with the stopper 240 along with the rotation of the arm 400. For example, when the connecting portion 420 passes the rear of the robot body 100 and is rotated closer to the ground than the first link 210, the rotation protrusion 480 may be in contact with the stopper 240.

With this configuration, when the arm 400 is rotated to a predetermined position, the rotation of the arm 400 may be limited while the stopper 240 and the rotation protrusion 480 are in contact and supported.

In addition, there is an effect of maintaining the posture of the arm 400 and the leg unit 200 while maintaining the state in which the stopper 240 and the rotation protrusion 480 support each other.

Meanwhile, FIG. 6 and FIG. 7 show diagrams to describe another embodiment of the arm in the robot according to the present disclosure.

Referring to FIG. 6 and FIG. 7, the arm 1400 according to another embodiment of the present disclosure will be described as follows.

In order to avoid repeated explanation, except for the contents specifically described in this embodiment, the structure and effect are the same as those of the arm 400 according to one embodiment of the present invention, so they can be used.

The arm 1400 of this embodiment further includes a terminal rotation portion 1460 and a switching motor MC that provides rotational force to the terminal rotation portion 1460.

The terminal rotation portion 1460 is rotatably coupled to the connecting portion 1420. For example, the terminal rotation portion 1460 may be formed in a plate shape having a predetermined thickness, and a detachable portion 1430 and a connection terminal 1440 may be arranged on one side.

The terminal rotation portion 1460 may form the outer appearance of the arm 1400 together with the connecting portion 1420. The terminal rotation portion 1460 may be provided with a rotation shaft coupled with the connecting portion 1420 at both ends in the longitudinal direction.

The switching motor MC may be connected to the terminal rotation portion 1460 and provide rotational force to the terminal rotation portion 1460. More specifically, the final output end of the shaft or gear of the switching motor MC is connected to the terminal rotation portion 1460.

With this configuration, when the switching motor MC is operated, the terminal rotation portion 1460 rotates.

When the terminal rotation portion 1460 is rotated, the surface exposed to the outside may be changed. Specifically, the terminal rotation portion 1460 may have one surface where the detachable portion 1430 and the connection terminal 1440 are arranged on the outside exposed to the outside. Then, when the terminal rotation portion 1460 is rotated, the detachable portion 1430 and the connection terminal 1440 may be hidden into the internal space of the connecting portion 1420.

With this configuration, when the combination of the arm 1400 and the function module is unnecessary, the detachable portion 1430 and the connection terminal 1440 may be hidden into the interior of the connecting portion 1420.

In particular, when the robot 1 falls over, it is necessary to rotate the arm 1400 so that the connecting portion 1420 touches the ground. At this time, the detachable portion 1430 and the connection terminal 1440 may become contaminated or damaged when they come into contact with the ground.

Therefore, according to the arm 1400 of the present embodiment, the detachable portion 1430 and the connection terminal 1440 may be prevented from being exposed to the outside by the rotation of the terminal rotational portion 1460. In addition, contamination or damage to the detachable portion 1430 and the connection terminal 1440 may be prevented.

### Robot Mask

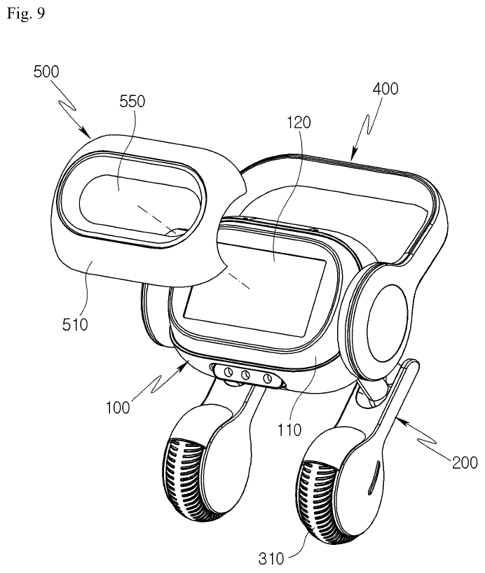

FIG. 9 shows a view to describe the relationship between the robot mask and the robot body in the robot according to one embodiment.

The robot 1 according to this embodiment may further include the robot mask 500.

The robot mask 500 is detachably coupled with the robot body 100 and may cover the display 120. The robot mask 500 may be coupled with the robot body 100 to form the exterior of the robot 1.

Meanwhile, the robot mask 500 according to one embodiment of, when coupled with the robot body 100, may include a window 550 that exposes an image displayed on the display 120 to the outside.

The window 550 may be arranged in the mask body 510. Specifically, the window 550 may be arranged to penetrate the mask body 510 and may be arranged at a position facing the display (120) when the robot mask 500 is coupled to the robot body 100.

The window 550 may be formed of a material that allows light to pass through. For example, the window 550 may be formed of a transparent material.

Meanwhile, when the robot mask 500 is combined with the robot body 100, the display 120 may display a face and facial expressions.

The robot 1 may display facial shapes such as eyes, nose, and mouth on the display 120 to make the user feel that the robot is expressing emotions.

In this way, the robot 1 may provide a pet robot service that displays emotions to the user and communicates with the user, and has the effect of providing emotional stability to the user.

The robot 1 may display emotions visually by displaying facial expressions on the display 120 as described above, and may also display emotions through voice output from the speaker 450.

For example, it can output sounds such as smiling and surprised sounds in response to the expressions displayed on the display 120.

In addition, the robot 1 may display emotions visually by displaying facial expressions on the display 120 as described above, and may also display emotions through rotation of the arm 400.

For example, it can display emotions by shaking the arm 400 while displaying a smiling expression on the display 120.

### Control Configuration

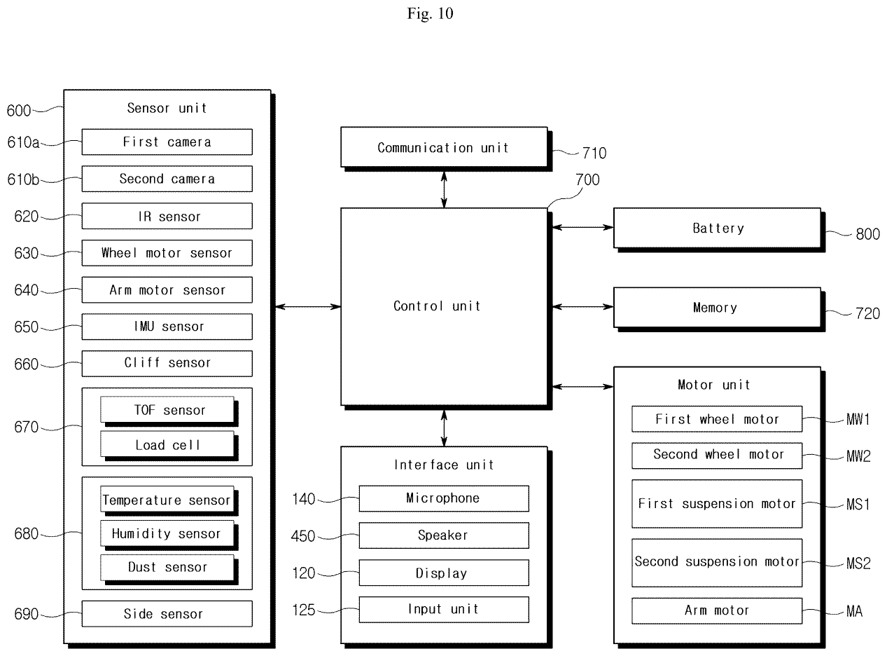

FIG. 10 is a block view to describe the control configuration of the robot according to one embodiment.

Referring to FIG. 10, the robot 1 according to one embodiment may include a sensor unit 600, a control unit 700, a communication unit 710, a memory 720, a battery 800, a motor unit, and an interface unit.

The components shown in the block diagram of FIG. 10 are not essential for implementing the robot 1, so the robot 1 described in this disclosure may have more or fewer components than the components listed above.

First, the control unit 700 may control the overall operation of the robot 1. The control unit 700 may control the robot 1 to perform various functions according to the setting information stored in the memory 720 described below.

The control unit 700 may be placed in the robot body 100. More specifically, the control unit 700 may be mounted and provided on a PCB placed inside the body housing 110.

The control unit 700 may include all types of devices capable of processing data, such as a processor. Here, the ‘processor’ may mean a data processing device built into hardware, for example, having a physically structured circuit to perform a function expressed by a code or command included in a program. As an example of a data processing device built into hardware, a microprocessor, a central processing unit (CPU), a processor core, a multiprocessor, an application-specific integrated circuit (ASIC), a field programmable gate array (FPGA), and the like may be included, but the scope of the present disclosure is not limited thereto.

The control unit 700 may receive information about the external environment of the robot 1 from at least one of the components of the sensor unit 600 described below. At this time, the information about the external environment can be, for example, information about the temperature, humidity, and amount of dust in the room where the robot 1 is driving. Or, for example, it can be cliff information. Or, for example, it can be indoor map information. Of course, the information about the external environment is not limited to the examples described above.

The control unit 700 may receive information about the current state of the robot 1 from at least one of the components of the sensor unit 600 described below. At this time, the current state can be, for example, information about the inclination of the robot body 100. Or, for example, information about the separation state between the wheel 310 and the ground. Or, for example, it can be position information of the wheel motor (MW). Or, for example, it can be position information of the suspension motor (MS). Of course, information about the current status of the robot 1 is not limited to the examples described above.

The control unit 700 may transmit a drive control command to at least one of the components of the motor unit to be described later. The control unit 700 may control the rotation of at least one of the wheel motor MW, the suspension motor MS, and the arm motor MA to implement one of the operations of driving, maintaining a posture, and changing a posture of the robot 1.

The control unit 700 may receive a user's command through at least one of the components of the interface unit to be described later. For example, the command can be a command to turn the robot 1 on/off. Or, for example, the command can be a command to manually control various functions of the robot 1.

The control unit 700 may output information related to the robot 1 through at least one of the configurations of the interface unit to be described later. For example, the information output may be visual information. Or, for example, the information output may be auditory information.

The motor unit includes at least one motor and can provide driving force to a configuration connected to each motor.

The motor unit may include a wheel motor MW that provides driving force to the left and right wheels 310. More specifically, the motor unit may include a first wheel motor MW1 that transmits driving force to the wheel 310 arranged on one side of the left and right directions and a second wheel motor MW2 that transmits driving force to the wheel 310 arranged on the other side of the left and right directions.

The wheel motors MW may be respectively arranged in the wheel unit 300. More specifically, the wheel motors MW may be accommodated inside the third link 230.

The wheel motor MW is connected to the wheel 310. More specifically, the final output end of the shaft or gear of the first wheel motor MW1 is connected to the wheel 310 arranged on one side in the left and right directions. The final output end of the shaft or gear of the second wheel motor MW2 is connected to the wheel 310 arranged on the other side in the left and right directions. Each of the left and right wheel motors MW is driven and rotated according to the control command of the control unit 700, and the robot 1 travels along the ground due to the rotation of the wheel 310 according to the rotation of the wheel motor MW.

The motor unit may include a suspension motor MS that provides driving force to the left and right leg units 200. More specifically, the motor unit may include a first suspension motor MS1 that transmits driving force to the leg unit 200 positioned on one side in the left and right directions, and a second suspension motor MS2 that transmits driving force to the leg unit 200 positioned on the other side in the left and right directions.

The suspension motor MS may be positioned in the robot body 100. More specifically, the suspension motor MS may be accommodated in the interior of the body housing 110, respectively.

The suspension motor MS is connected to the first link 210. More specifically, the final output end of the shaft or gear of the first suspension motor MS1 is connected to the first link 210 arranged on one side in the left and right directions. The final output end of the shaft or gear of the second suspension motor MS2 is connected to the first link 210 arranged on the other side in the left and right directions. Each of the suspension motors MS on the left and right sides is driven and rotated according to the control command of the control unit 700, and the first link 210 rotates according to the rotation of the suspension motor MS, and the third link 230 connected to the first link 210 rotates, and as a result, the angle between the first link 210 and the third link 230 may be changed.

Through this, the robot 1 may perform an operation of lifting or lowering the wheel 310, and may maintain a horizontal posture when climbing an obstacle or driving on a curved surface. Alternatively, the robot body 100 may move downward or upward.

The motor section may include an arm motor MA that provides rotational force to the arm 400.

The arm motor (MA) may be placed in the robot body (100). More specifically, at least one arm motor (MA) may be accommodated inside the body housing (110).

The arm motor MA is driven and rotates according to the control command of the control unit 700, and the rotational coupling portion 410 rotates according to the rotation of the arm motor MA, and the connecting portion 420 formed integrally with the rotational coupling portion 410 rotates, resulting in pivot movement of the arm 400 relative to the robot body 100.

Through this, the robot 1 may perform an operation of rotating the arm 400, and the arm 400 may be rotated to be coupled with the function module. Alternatively, the arm 400 may be made to touch the ground through the rotation of the arm 400.

The sensor unit 600 includes at least one sensor, and each sensor can measure or detect information about the external environment of the robot 1 and/or information about the current state of the robot 1.

The sensor unit 600 may include a first camera 610a.

The first camera 610a is provided to map the indoor space in which the robot 1 runs. The first camera 610a may be referred to as a mapping camera 610a.

For this purpose, the first camera 610a may be placed in front of the robot body 100. More specifically, the first camera 610a may be placed in the remaining space of the body housing 110.

The first camera 610a may capture an indoor scene while driving to perform SLAM (Simultaneous Localization and Mapping). The control unit 700 may implement SLAM based on information about the surrounding environment captured by the first camera 610a and information about the current location of the robot 1.

Meanwhile, the method by which the robot 1 according to the embodiment of the present invention implements SLAM may be implemented only with the first camera 610a, but is not limited thereto. For example, the robot 1 may implement SLAM by further utilizing an additionally equipped sensor. The additional sensor may be, for example, an LDS (Laser Distance Sensor).

The sensor unit 600 may include a second camera 610b.

The second camera 610b is a configuration provided to recognize the location, distance, height, etc. of an object (object, human body, etc.) existing in front of the driving direction. The second camera 610b may be referred to as a depth camera.

The second camera 610b may be placed in front of the robot body 100 to detect an object in front when the robot 1 moves forward. The second camera 610b may be additionally placed in the rear of the robot body 100 to detect an object in the rear when the robot 1 moves backward.

The second camera 610b may capture a front view (front view when moving forward, rear view when moving backward) of the direction in which the robot 1 moves to recognize the position of the object. To this end, the second camera 610b may each be equipped with a Depth module and an RGB module.

The Depth module may obtain depth information of the image. For example, the depth information may be obtained by measuring the delay or phase shift of a modulated optical signal for all pixels of the image being captured to obtain movement time information.

The RGB module can obtain a color image (image image). Edge characteristics, color distribution, frequency characteristics (or wavelet transform), etc. can be extracted from the color image.

In this way, the distance and/or height information for the recognition target object may be obtained through depth information from the front image captured by the second camera 610b, and the boundary characteristics extracted from the color image may be calculated together to recognize whether an object exists in front and/or its location.

The sensor unit 600 may include an IR sensor 620 for infrared detection.

The IR sensor 620 may be an IR camera that detects infrared light.

The IR sensor 620 may be placed on the robot body 100. More specifically, the IR sensor 620 may be placed on the front of the body housing 110. The IR sensor 620 may be placed left and right of the first camera 610a.

The IR sensor 620 may detect infrared light emitted by an IR LED equipped in a specific module and approach the module. For example, the module can be a charging station for charging the robot 1. For example, the module may be a functional module that is detachably provided on the arm 400.

The control unit 700 may control the IR sensor 620 to start detecting the IR LED when the charging status of the robot (1) is below a preset level. The control unit 700 may control the IR sensor 620 to start detecting the IR LED when a command to find a specific module is received from the user.

The sensor unit 600 may include a wheel motor sensor 630.

The wheel motor sensor 630 may measure the position of the wheel motor MW. For example, the wheel motor sensor 630 may be an encoder. As is well known, an encoder can detect the position of a motor and also detect the rotation speed of the motor.

The wheel motor sensors 630 may be respectively placed on the left and right wheel motors MW. More specifically, the wheel motor sensor 630 may be connected to the shaft or the final output end of the gear of the wheel motor MW and may be accommodated inside the third link 230 together with the wheel motor MW.

The sensor unit 600 may include an arm motor sensor 640.

The arm motor sensor 640 may measure the position of the arm motor MA. For example, the arm motor sensor 640 may be an encoder. As is well known, an encoder can detect the position of a motor and also detect the rotation speed of the motor.

The arm motor sensor 640 may be placed on the arm motor MA. More specifically, the arm motor sensor 640 may be connected to the final output end of the shaft or gear of the arm motor MA and may be accommodated inside the robot body housing 110 or the rotational coupling portion 410 together with the arm motor MA.

The sensor unit 600 may include an IMU sensor 650.

The IMU sensor 650 may measure the tilt angle of the robot body 100.

As is well known, the IMU (Inertial Measurement Unit) sensor 650 is a sensor that incorporates a three-axis acceleration sensor, a three-axis gyro sensor, and a geomagnetic sensor, and is also referred to as an inertial measurement sensor.

The three-axis acceleration sensor is a sensor that detects the gravitational acceleration of an object in a stationary state. Since the gravitational acceleration varies depending on the angle at which the object is tilted, the tilt angle can be obtained by measuring the gravitational acceleration. However, there is a disadvantage in that the correct value cannot be obtained in a moving acceleration state, not a stationary state.

A three-axis gyro sensor is a sensor that measures angular velocity. When the angular velocity is integrated over the entire time, the inclination angle is obtained. However, the angular velocity measured by the gyro sensor has continuous errors due to noise, etc., and due to these errors, errors in the integral value accumulate and occur over time.

As a result, when a long time passes in a stationary standby state, the robot 1 may accurately measure the inclination by the acceleration sensor, but errors occur by the gyro sensor. When driving, the robot 1 may accurately measure the inclination value by the gyro sensor, but may not obtain the correct value by the acceleration sensor.

Using an IMU sensor can complement the shortcomings of the acceleration sensor and gyro sensor described above.

This present disclosure describes an embodiment in which an IMU sensor is provided.

The IMU sensor may be placed on the robot body 100. More specifically, the IMU sensor may be placed adjacent to the control unit 700. The IMU sensor may be mounted and provided on a PCB inside the robot body 100. In order to improve the measurement accuracy of the tilt angle and direction, it is preferable that the IMU sensor be placed close to the central area of the robot body 100.

The IMU sensor may measure at least one of the three-axis acceleration, three-axis angular velocity, and three-axis geomagnetic data of the robot body 100 and transmit the data to the control unit 700.

The control unit 700 may calculate the tilted direction and tilted angle of the robot body 100 using at least one of the acceleration, angular velocity, and geomagnetic data received from the IMU sensor. Based on this, the control unit 700 may perform horizontal posture maintenance control of the robot body 100, which will be described later.

The sensor unit 600 may include a cliff sensor 660 for detecting a cliff.

The cliff sensor 660 may be configured to detect the distance from the front ground on which the robot 1 is traveling. The cliff sensor 660 may be formed in various ways within a range that can detect the relative distance between the point where the cliff sensor 660 is formed and the ground.

For example, the cliff sensor 660 may be formed by including a light-emitting part that irradiates light and a light-receiving part where reflected light is incident. The cliff sensor 660 may be formed by an infrared sensor.

The cliff sensor 660 may be placed on the robot body 100. More specifically, the cliff sensor 660 may be placed on the inside of the robot body 100. The cliff sensor 660 may irradiate light toward the front floor surface of the robot 1. The cliff sensor 660 may detect in advance whether a cliff exists in the forward direction of the robot 1.

The light-emitting portion of the cliff sensor 660 may irradiate light obliquely toward the front floor surface. The light-receiving portion of the cliff sensor 660 may receive light reflected from the floor surface and incident thereon. The distance between the front ground and the cliff sensor 660 may be measured based on the difference between the irradiation time and the reception time of the light.

If the distance measured by the cliff sensor 660 exceeds a preset value or a preset range, it may be a case where the front ground suddenly lowers. A cliff can be detected using this principle.

The control unit 700 may control the wheel motor MW so that the robot 1 can drive to avoid the detected cliff when a cliff is detected in front. At this time, the control of the wheel motor MW may be a stop control. Alternatively, the control of the wheel motor MW may be a rotation direction switching control.

The sensor unit 600 may include a contact detection sensor 670.

The contact detection sensor 670 may detect whether the wheel 310 has contacted the ground.

The contact detection sensor 670 may include a TOF sensor that measures the distance between the wheel 310 of the robot 1 and the ground. The TOF sensor can be a 3D camera to which TOF (Time of Flight) technology is applied. TOF technology, as is well known, is a technology that measures the distance to an object based on the round-trip flight time for light irradiated toward the object to be reflected and returned.

The TOF sensor may be placed on the wheel unit 300. For example, the contact detection sensor 670 may be placed on each of the left and right third links 230. It may be determined whether the wheel 310 is in contact with the ground based on the distance from the ground measured by the TOF sensor. If the distance measured by the TOF sensor is less than a preset distance (or less than a lower limit of the preset distance range), the wheel 310 is in contact with the ground. If the distance measured by the TOF sensor is greater than or equal to a preset distance (or greater than or equal to an upper limit of the preset distance range), the wheel 310 is separated from the ground.

The contact detection sensor 670 may include a load cell that measures the magnitude of force applied to a part of the robot 1.

As is well known, when force is applied to the load cell, the resistance value of the strain gauge provided on the surface changes. At this time, the magnitude of the force applied to the load cell can be measured through the change in the resistance value.

The load cell may be placed in the leg unit 200. Preferably, the load cells may be placed in each of the left and right third links 230. When the wheel 310 is in contact with the ground, the third link 230 is deformed by a vertical force applied from the ground. The measured value of the load cell appears as a different value from the initial value depending on the deformation of the third link 230. Through this, it can be determined whether the wheel 310 is in contact with the ground.

The sensor unit 600 may include an environmental sensor 680.

The environmental sensor 680 may be configured to measure various environmental conditions outside the robot 1, i.e., the inside of the house where the robot 1 is driving. The environmental sensor 680 may include at least one of a temperature sensor, a humidity sensor, and a dust sensor.

The environmental sensor 680 may be placed in the robot body 100. More specifically, the environmental sensor 680 may be placed at the rear of the robot body 100. As a possible embodiment, information measured by the environmental sensor 680 may be visually displayed on the display 120.

The sensor unit 600 may include a side sensor 690.

The side sensor 690 may measure the distance to an obstacle, including a wall, etc.

The side sensor 690 may be configured to detect the distance from the wall surface on the side where the robot 1 is running. The side sensor 690 may be configured in various ways within a range that can detect the relative distance between the point where the side sensor 690 is placed and the obstacle.

For example, the side sensor 690 may be configured to include a light-emitting unit that irradiates light and a light-receiving unit where reflected light is incident. The side sensor 690 may be configured as an infrared sensor.

The side sensor 690 may be placed on both sides of the robot 1. For example, the side sensor 690 may be placed on the outer surface of the third link 230 of the leg unit 200.

The interface unit includes at least one configuration for interaction between a user and the robot 1, and each configuration may be equipped to input a command from a user and/or output information to the user.

The interface section may include a microphone 140.

The microphone 140 is a configuration that recognizes the user's voice, and may be provided in multiple numbers. The microphone 140 may be arranged in multiple numbers in the robot body housing 110. For example, four microphones 140 may be arranged on the upper side of the robot body housing 110.

The voice signal received by the microphone 140 may be used to track the user's location. At this time, a known sound source tracking algorithm can be applied. For example, the sound source tracking algorithm can be a three-point measurement method (triangulation method) using the time difference between multiple microphones 140 receiving the voice signal. The principle is that the location of the voice source is calculated using the location of each microphone 140 and the speed of the sound wave.

Meanwhile, if the microphone 140 and the first camera 610a described above cooperate with each other, the robot 1 may be implemented to find the user's location even when the user calls the robot 1 from a far-away place.

The interface unit can include a speaker 450.

The speaker 450 may be placed on the arm 400. For example, the speaker 450 may be placed on the rotational coupling portion 410 of the arm 400. Speakers 450 may be placed at positions covering both left and right sides of the robot body housing 110.

The speaker 450 may transmit information of the robot 1 as sound. The source of the sound transmitted by the speaker 450 may be sound data previously stored in the robot 1. For example, the previously stored sound data may be voice data of the robot 1. For example, the previously stored sound data may be a notification sound that guides the status of the robot 1. Meanwhile, the source of the sound transmitted by the speaker 450 may be sound data received through the communication unit 710.

The interface unit may include a display 120 and an input unit 125.

The display 120 may include a display arranged in one or more modules. The display 120 may be arranged on the front upper side of the robot body 100.

The display 120 may be formed of any one of a light emitting diode (LED), a liquid crystal display (LCD), a plasma display panel, and an organic light emitting diode (OLED).

The display 120 may display information such as operating time information of the robot 1, battery 800 power information, etc.

The display 120 may display the facial expression of the robot 1. Alternatively, the display 120 may display the pupils of the robot 1. The current state of the robot 1 may be personified and expressed as an emotion through the shape of the face or the shape of the pupils displayed on the display 120. For example, when the user goes out and returns home, the display 120 may display a smiling facial expression or smiling eye shape. This provides an effect where the user feels a sense of communication with the robot 1.

The input unit 125 may be configured to receive a control command for controlling the robot 1 from the user. For example, the control command may be a command for changing various settings of the robot 1. For example, the settings may be voice volume, display brightness, power saving mode settings, etc.

The input unit 125 may be placed on the display 120.

The input unit 125 generates key input data that the user inputs to control the operation of the robot 1. For this purpose, the input unit 125 may be composed of a key pad, a dome switch, a touch pad (static/electrostatic), etc. In particular, when the touch pad forms a mutual layer structure with the first display, it may be called a touch screen.

The communication unit 710 may be provided for signal transmission between each component within the robot 1. The communication unit 710 may support, for example, CAN (Controller Area Network) communication. The signal may be, for example, a control command transmitted from the control unit 700 to another component.

The communication unit 710 may support wireless communication with other devices existing outside the robot 1. A short-range communication module or a long-range communication module may be provided as a wireless communication module for supporting wireless communication.

Short-range communication can be, for example, Bluetooth communication, NFC (Near Field Communication), etc.

Long-distance communication includes, for example, Wireless LAN (WLAN), Digital Living Network Alliance (DLNA), Wireless Broadband (Wibro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTEA), Wireless Mobile Broadband Service (WMBS), Bluetooth Low Energy (BLE), Zigbee, and Radio Frequency (RF). LoRa (Long Range), etc.

The memory 720 is a configuration in which various data for driving and operating the robot 1 are stored.

The memory 720 may store an application program for autonomous driving of the robot 1 and various related data. The memory 720 may also store each data sensed by the sensor unit 600, and may store setting information for various settings selected or input by the user.

The memory 720 may include a magnetic storage media or a flash storage media, but the scope of the present invention is not limited thereto. Such memory 720 may include internal memory and/or external memory, and may include volatile memory such as DRAM, SRAM, or SDRAM, nonvolatile memory such as OTPROM (one time programmable ROM), PROM, EPROM, EEPROM, mask ROM, flash ROM, NAND flash memory, or NOR flash memory, flash drives such as SSD, CF (compact flash) card, SD card, Micro-SD card, Mini-SD card, Xd card, or memory stick, or storage devices such as HDD.

The memory 720 may be included in the control unit 700 or may be provided as a separate component.

The battery 800 is configured to supply power to other components forming the robot 1.

The battery 800 may be placed in the robot body 100. More specifically, the battery 800 may be accommodated inside the robot body housing 110. Although not shown, the battery 800 may be placed behind the suspension motor MS.

The battery 800 may be charged by an external power source, and for this purpose, a charging terminal 130 for charging the battery 800 may be provided on one side of the robot body 100. As in the embodiment of the present invention, the charging terminal 130 may be placed at the bottom of the robot body 100. In this way, the robot 1 may be easily coupled with the charging station by approaching the charging station and descending, thereby placing the charging terminal 130 on the corresponding terminal of the charging station from above.

### Basic Driving Posture of the Robot

The robot 1 may drive on the ground in a preset basic posture as illustrated in FIG. 1. The basic posture may refer to the posture of the robot 1 in a state where a specific event does not occur. The specific event may be caused by a change in the external environment in which the robot 1 drives, a user's control command, or satisfaction/dissatisfaction of a condition preset for the robot 1.

In the basic posture, the connecting portion 420 of the arm 400 may be placed on the upper side of the robot body 100. More specifically, in the basic posture, the connecting portion 420 may be placed farther from the ground than the robot body 100. With this configuration, the user can easily lift the robot 1 by grasping the connecting portion 420. This can help the user easily transport the robot 1 and quickly move the robot 1 to another space. In other words, the arm 400 may be provided as a handle to the user.

In the basic posture, the connection portion 420 of the arm 400 may be placed at the rear of the robot body 100. Preferably, in the basic posture, the connection portion 420 may be placed at the rear of the robot mask 500. As a result, when the user looks at the robot 1, the robot mask 500 may be covered by the arm 400, thereby preventing the visibility of the display from being reduced.

In the basic posture, balance control may be performed so that the robot 1 does not fall forward or backward. At this time, balance control means control to rotate the wheel 310 forward or backward by rotating the wheel motor MW based on the degree of inclination of the robot 1.

If the robot 1 is tilted forward more than the inclination of the preset basic posture, the wheel motor MW may be driven to rotate the wheel 310 backward so that the robot 1 returns to the basic posture.

If the robot 1 is tilted backward more than the inclination of the preset basic posture, the wheel motor MW may be driven to rotate the wheel 310 forward so that the robot 1 may returns to the basic posture.

Meanwhile, as described above, the degree of tilt of the robot 1 may be measured by the IMU sensor 650.

The robot 1 drives on the ground using the rotation drive of the wheel 310 while maintaining the basic posture described above, and when detecting a driving obstacle located in the driving path of the wheel 310, it may perform a response motion according to the type of the driving obstacle.

At this time, the driving obstacle refers to an object such as an obstacle or a cliff that exists in the driving path of the robot 1 and cause an accident such as a collision or a fall when the robot (1) continues to drive in the basic posture.

Such a driving obstacle can be detected by the sensor unit.

More specifically, the depth camera 610b may detect the driving obstacle. Or, the cliff sensor 660 may detect the driving obstacle.

In the robot 1 according to the embodiment of the present disclosure, when a response motion to a driving obstacle is performed, the rotational drive of the arm 400 (or, it can also be referred to as a rotational motion of the arm 400) may be necessarily performed. At this time, an operation in which the position of the connecting portion 420 is changed by the rotational drive of the arm 400 may be accompanied.

In the embodiment of the present invention, the leg unit 200 of the robot 1 may include an upper link and a lower link.

The upper link may be defined as a concept including the first link 210 and the second link 220, which are link structures arranged on the side of the robot body 100. The lower link may be defined as a concept including the third link 230, which is a link structure arranged on the side of the wheel 310.

The upper link and the lower link may be linked to each other to form a joint structure. Through the movement of the joint structure, the robot body 100 may move up or down during driving.

More specifically, the upper link and the lower link may maintain a constant coupling angle in the basic posture of the robot 1. Here, the coupling angle of the upper link and the lower link may mean the coupling angle between the first link 210 and the third link 230. The above-mentioned coupling angle may mean an acute angle formed by the first link 210 and the third link 230 based on the connection point of the first link 210 and the third link 230.

The adjustment of the coupling angle, i.e., the movement of the above-mentioned joint structure, may be implemented by controlling the driving of the suspension motor MS. As the suspension motor MS rotates and the coupling angle decreases, the robot body 100 may descend toward the ground. As the suspension motor MS rotates and the coupling angle increases, the robot body 100 may rise in the opposite direction to the ground.

Meanwhile, as explained above, in the basic posture of the robot 1, the above-mentioned coupling angle can be maintained at a size formed by the restoring force of the gravity compensation unit. Since the restoring force of the gravity compensation unit is applied, the rotational drive of the suspension motor MS to maintain the basic posture is unnecessary.

### Response Motion when Detecting an Upper Obstacle

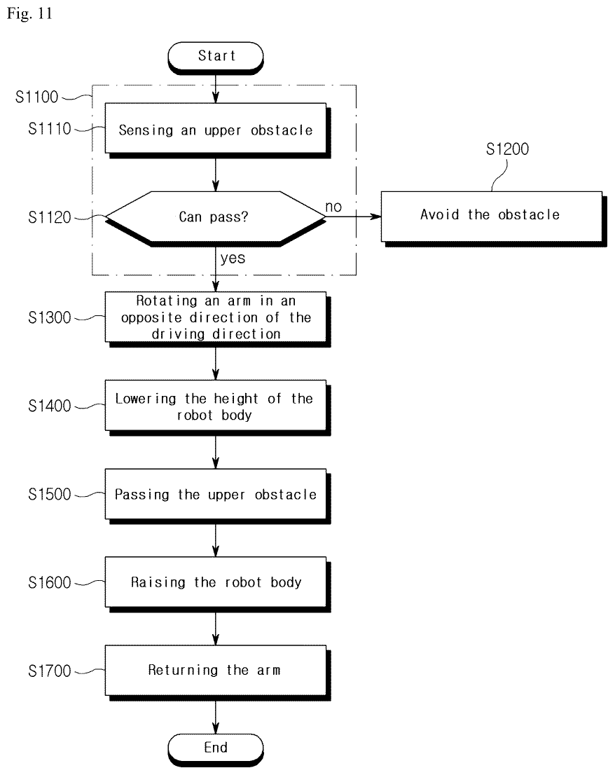

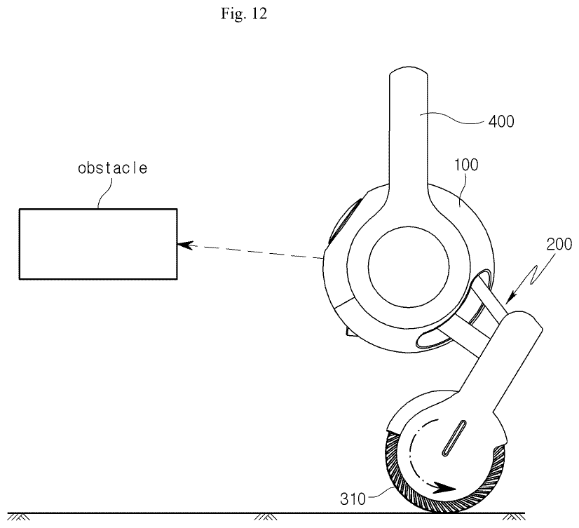

FIG. 11 is a flow chart showing a control method of a robot that is performed to respond to an upper obstacle existing ahead in a driving direction. FIGS. 12 to 17 sequentially showing a response motion of the robot performed in the embodiment of FIG. 11.

Each step of the control method illustrated in FIGS. 11 to 17 and described below can be performed by the control unit 700.

The control method of the robot to respond to an upper obstacle may include a sensing step S1100 in which the sensor unit 600 of the robot 1 detects an upper obstacle (see FIG. 12).

Here, the upper obstacle means an obstacle that exists at a certain height above the ground, and is an obstacle located at a position where it collides with a part of the robot 1 when the robot 1 continues to move in the driving direction. For example, an object supported from the ground by multiple legs, such as the top of a table or desk, may correspond to this.

The upper obstacle may be detected by the sensor unit 600. S1110.

More specifically, it may be detected by the depth camera 610b. As described above, the depth camera 610b may measure whether an object exists in front of the camera, the distance to the object, and the height.

The depth camera 610b may measure the first height from the ground to the lower end of the upper obstacle. The measured first height is compared with the second height to determine whether the robot 1 may pass under the detected upper obstacle S1120.

Here, the second height can be defined as the minimum height of the robot 1 that can be implemented by rotating the joint structure of the arm 400 and the leg unit 200. Information on the second height may be stored in advance in the memory 720. The size comparison of the first height and the second height can be calculated by the control unit 700.

Based on the result of comparing the first height and the second height, it is determined whether to pass or avoid the upper obstacle. At this time, avoidance means changing the driving direction so as not to pass under the upper obstacle but to turn.

If the first height is lower than the second height, a response motion is determined to avoid the upper obstacle S1200. The robot 1 may avoid the upper obstacle by changing direction, such as moving backward, turning left, or turning right.

If the first height is higher than the second height, a corresponding motion is determined to pass through the upper obstacle.

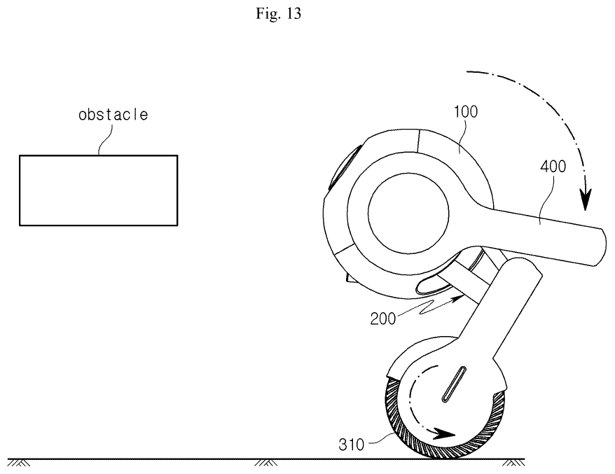

A method for controlling a robot to respond to an upper obstacle may further include an arm rotation step S1300 (see FIG. 13).

This step S1300 is performed when it is determined to pass through the upper obstacle in the previous step S1100. The arm 400 may be rotated by the rotation drive of the arm motor MA.

At this time, the arm 400 of the integrated structure coupled to the left and right sides of the robot body 100 is rotated in the opposite direction to the driving direction of the robot 1.

If the robot 1 was driving forward, the arm 400 is rotated toward the rear.

If the arm 400 was driving backward, the arm is rotated toward the front.

Through this configuration, it is possible to prevent the arm 400 from blocking the view of the sensor unit 600 that is detecting a driving obstacle.

In this step S1300, the arm 400 is rotated so as to be positioned lower than the upper end of the robot body 100. More specifically, the arm 400 is controlled to rotate until the upper end of the connecting portion 420 is positioned lower than the upper end of the robot body 100.

By performing this step S1300, the overall height of the robot 1 may be lowered.

Meanwhile, when the arm 400 rotates, the overall center of gravity of the robot 1 may be shaken, but the robot 1 may be prevented from falling over by controlling the balance of the wheel 310.

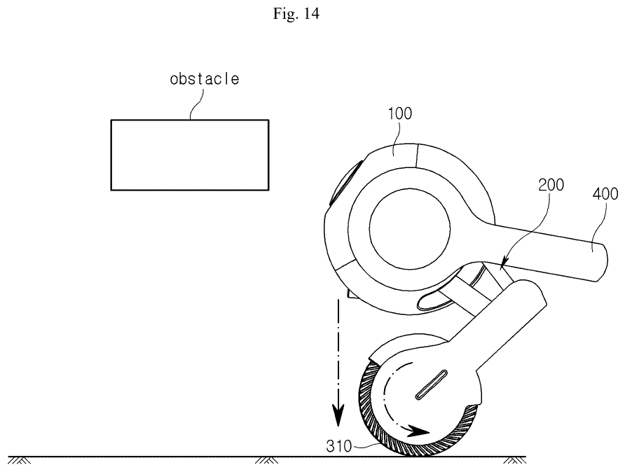

The control method of the robot to respond to an upper obstacle can further include a leg control step S1400 (see FIG. 14).

In this step S1400, the coupling angle of the joint structure of the leg unit 200 may be controlled so that the robot body 100 comes closer to the ground.

The coupling angle of the joint structure of the leg unit 200 may be varied by the rotational drive of the suspension motor MS. As described above, the coupling angle of the leg unit 200 may refer to the coupling angle of the upper and lower links.

In this step S1400, the suspension motor MS may be rotated until the coupling angle becomes the minimum angle. In other words, the suspension motor MS may be rotated until the robot body 100 and the wheel 310 (or the ground) become as close as possible.

By performing this step S1400, the overall height of the robot 1 may be further reduced.

Meanwhile, when controlling the joint structure of the leg unit 200, the overall center of gravity of the robot 1 may shake, but the robot 1 may be prevented from falling through the balance control of the wheel 310.

The arm rotation step S1300 and the leg control step S1400 may be performed sequentially or simultaneously. Each step is performed to lower the height of the robot 1, and any step can be performed first (or simultaneously) as long as it is performed before reaching the upper obstacle.

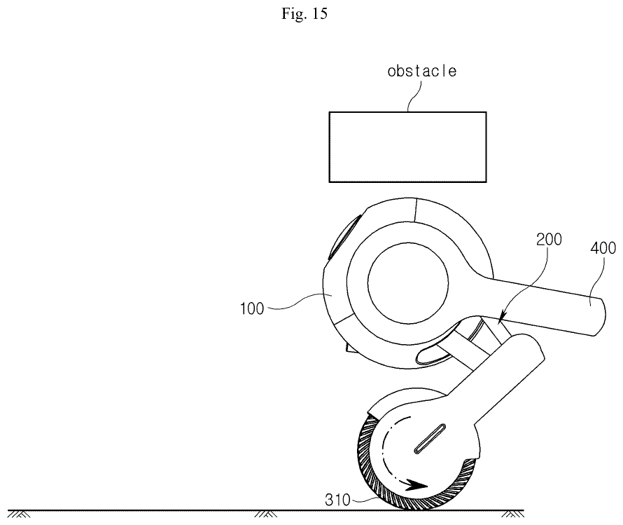

After the overall height of the robot 1 is lowered in the previous steps S1300 and S1400, the robot 1 may pass through the upper obstacle S1500 (see FIG. 15).

After passing through the upper obstacle, the robot 1 must return to the basic posture.

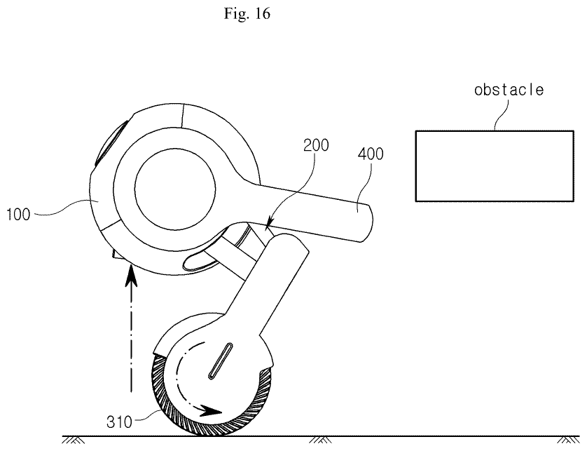

The control method of a robot for responding to an upper obstacle may further include a robot body rising step S1600 (see FIG. 16).

In this step S1600, the suspension motor MS may be driven to rotate until the engagement angle of the leg unit 200 becomes the engagement angle corresponding to the basic posture. That is, the suspension motor MS may be driven to rotate in the direction in which the robot body 100 and the wheel 310 (or the ground) move away.

After the engagement angle of the leg unit 200 becomes the engagement angle corresponding to the basic posture, the operation of the suspension motor MS may be stopped. Since the gravity applied by the robot body 100 toward the ground and the restoring force of the gravity compensation part are offset by the gravity compensation unit, the engagement angle of the leg unit 200 may be maintained even if the suspension motor MS is stopped.

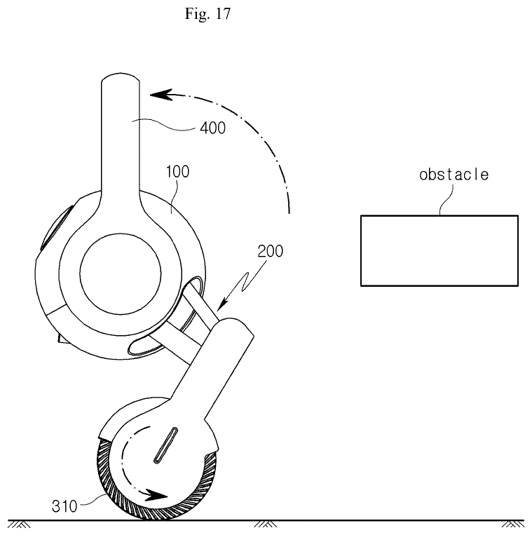

The control method of a robot to respond to an upper obstacle may further include an arm position return step S1700 (see FIG. 17).

In this step S1700, the arm motor MA may be driven to rotate so that the arm 400 returns to a position corresponding to the basic posture. The arm motor MA may be rotated in the opposite direction to the rotation direction in step S1300.

In this way, according to the embodiment of the present disclosure, when an upper obstacle exists, the joint structure of the arm 400 and the leg unit 200 may be controlled to lower the overall height of the robot 1, and the robot 1 may pass through the upper obstacle without having to change the driving path.

### Response Motion when Detecting a Cliff

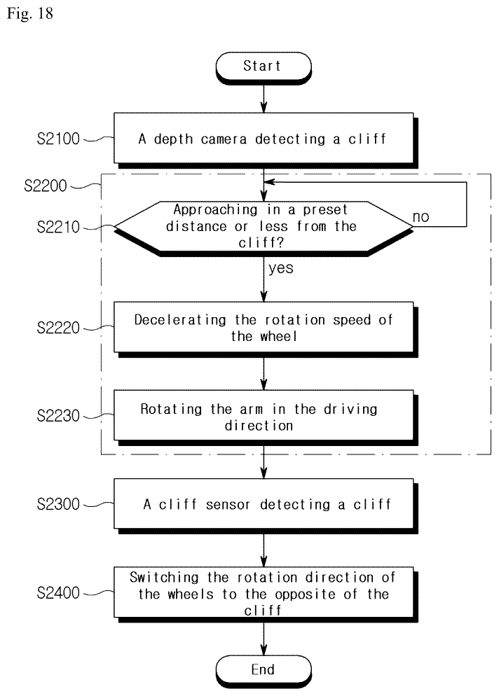

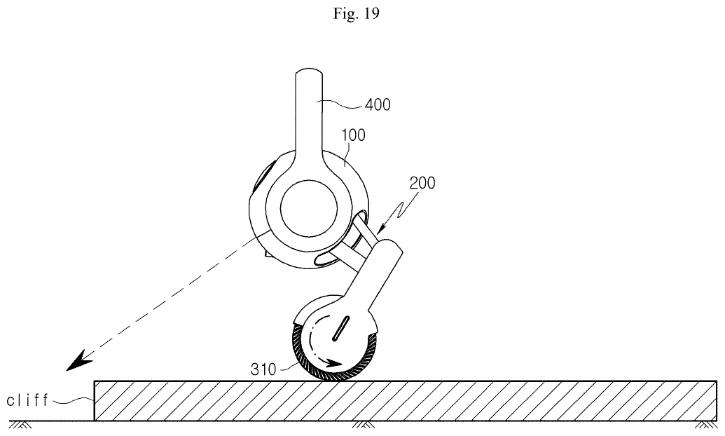

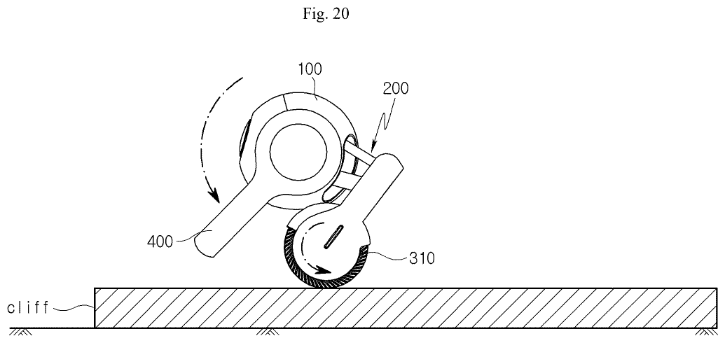

FIG. 18 is a flow chart showing a control method of a robot that is performed to respond to a cliff existing ahead in a driving direction. FIGS. 19 to 21 sequentially showing a response motion of the robot performed in the embodiment of FIG. 18.

Each step of the control method illustrated in FIGS. 18 to 21 and described below may be performed by the control unit 700.

The control method of the robot for responding to a cliff may include a first detection step S2100 (see FIG. 19)

In this step S2100, a cliff existing in front of the driving direction of the robot 1 may be detected by the depth camera 610b. The depth camera 610b may measure the distance to the ground while looking at the front of the robot 1.

Through this, a cliff, which is a point where the distance to the ground suddenly increases, i.e., a point where the ground suddenly becomes lower, may be detected.

The control method of the robot for responding to a cliff may further include a first motion step S2200.

More specifically, if a cliff is detected by the depth camera 610b in the previous step, the robot 1 may measure the distance to the cliff while continuing to drive.

At this time, if the distance to the cliff approaches a preset distance or less, the rotation speed of the wheel 310 may be slowed down. S2210 and S2220 As the rotation speed of the wheel 310 is slowed down, the speed at which the robot 1 is driving is also slowed down, and time is secured to perform additional motion in preparation for the cliff.

The suspension motor MS is connected to the first link 210. More specifically, the final output end of the shaft or gear of the first suspension motor MS1 is connected to the first link 210 arranged on one side in the left and right directions. The final output end of the shaft or gear of the second suspension motor MS2 is connected to the first link 210 arranged on the other side in the left and right directions. Each of the suspension motors MS on the left and right sides is driven and rotated according to the control command of the control unit 700, and the first link 210 rotates according to the rotation of the suspension motor MS, and the third link 230 connected to the first link 210 rotates, and as a result, the angle between the first link 210 and the third link 230 may be changed.

If the robot 1 was moving forward, the arm 400 is rotated toward the front.

If the robot 1 was moving backward, the arm 400 is rotated toward the rear.

The rotation of the arm 400 may be performed until the lower end of the arm 400 is positioned at the lower front side of the robot body 100. From another perspective, the arm 400 may be rotated until the connecting portion 420 of the arm 400 is positioned closer to the ground than the robot body 100. From another perspective, the connecting portion 420 of the arm 400 may be positioned closer to the wheel 310 than the robot body 100.

Meanwhile, when the arm 400 rotates, the overall center of gravity of the robot 1 may shake, but the robot 1 may be prevented from falling over through balance control of the wheel 310.

The control method of a robot to respond to a cliff may further include a second detection step S2300.

In this step S2300, a cliff existing in front of the driving direction of the robot 1 may be detected by the cliff sensor 660.

While the depth camera 610b is used to look forward at a long distance, the cliff sensor 660 may be used to look down at a short distance. For this purpose, the cliff sensor 660 may be placed on the front lower side of the robot body 100. The cliff sensor 660 may be additionally placed on the rear side of the lower link of the leg part 200.

The control method of the robot for responding to a cliff may further include a second motion step S2400.

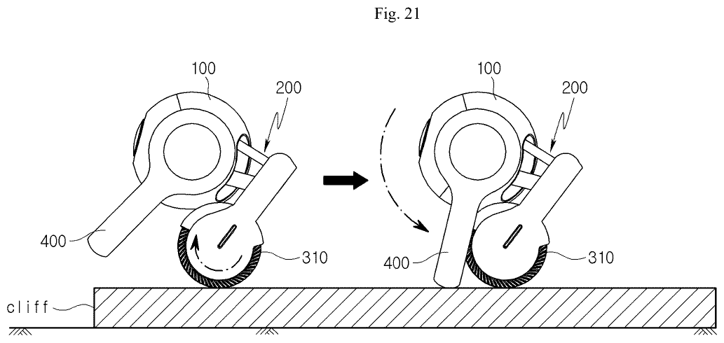

In this step S2400, the rotation direction of the wheel 310 may be switched so that the robot 1 travels in the opposite direction of the cliff. The wheel 310 may be rotated by the rotation drive of the wheel motor MW (see FIG. 21).

If the robot 1 detects a cliff while driving forward, the wheel 310 rotates backward.

If the robot 1 detects a cliff while driving backward, the wheel 310 rotates forward.

When the cliff sensor 660 detects a cliff, the wheel 310 will already be close to the cliff. Previously, robots that implemented cliff detection, or so-called fall prevention, were mainly autonomous cleaning robots. Autonomous cleaning robots do not have a joint structure, but rather have wheels directly connected to the bottom of the robot body. Therefore, the overall height is very low, and even if the driving direction is quickly changed immediately after cliff detection, there is no worry about losing the center of gravity and falling over.

On the other hand, the structure of the robot according to the embodiment of the present disclosure, in which the robot body 100 and the wheel 310 are connected by the leg joint, is a structure in which the entire center of gravity is positioned high. If the robot 1 with such a structure quickly changes the driving direction as soon as the cliff sensor 660 detects a cliff, the robot 1 may fall over due to the center of gravity being tilted toward the original driving direction (opposite of the changed driving direction) by the inertial force.

In the embodiment of the present disclosure, the arm 400 is rotated in the driving direction in advance before the second detection step in which the cliff sensor 660 detects a cliff.

That is, when the robot 1 changes its driving direction and the center of gravity is concentrated in one direction, the arm 400 has already moved in the direction in which the center of gravity is concentrated, so that the connecting portion 420 of the arm 400 touches the ground, and the robot body 100 is prevented from hitting the ground and falling over. As a result, various sensors equipped in the robot body 100 may be protected without the risk of being damaged by impact with the ground.

Although the present invention has been described with reference to the exemplified drawings, it is to be understood that the present invention is not limited to the embodiments and drawings disclosed in this specification, and those skilled in the art will appreciate that various modifications are possible without departing from the scope and spirit of the present invention.

Further, although the operating effects according to the configuration of the present invention are not explicitly described while describing an embodiment of the present invention, it should be appreciated that predictable effects are also to be recognized by the configuration.

1. A robot comprising:
a robot body that accommodates a battery;
two wheels disposed in a lower portion of the robot body;
two leg units connected between the robot body and the wheels;
an arm having an integrated structure including a pair of rotational coupling portions disposed on left and right sides of the robot body, respectively, to be rotatably coupled thereto, and a connecting portion interconnecting the pair of rotational coupling portions; and
a sensor unit configured to detect a driving obstacle positioned in a driving path of the wheels,
wherein when the sensor unit detects the driving obstacle, a preset response motion is performed, and the response motion comprises a rotation motion of the arm.

2. The robot of claim 1, wherein if the driving obstacle is an upper obstacle existing in an upper area in front of the driving direction of the wheel, the response motion determines whether to pass or avoid the upper obstacle by measuring the height from the ground to a lower end of the upper obstacle.

3. The robot of claim 1, wherein if the driving obstacle is an upper obstacle existing in an upper area in front of the driving direction of the wheel, the response motion rotates the arm so that an upper end of the arm is positioned lower than an upper end of the robot body, but the rotation direction of the arm is opposite to the driving direction of the robot.

4. The robot of claim 1, wherein each of the leg units comprises,
an upper link linked to the robot body; and
a lower link linked to the wheels, and
if the driving obstacle is an upper obstacle existing in an upper area in front of the driving direction of the wheels, the response motion reduces a coupling angle between the upper link and the lower link so that the robot body moves toward the ground.

5. The robot of claim 1, wherein the sensor unit comprises a depth camera, and
if the driving obstacle is a cliff existing in a lower area in front of the driving direction of the wheels, when the depth camera detects the existence of the cliff and the distance to the cliff approaches a preset distance or less, the response motion decelerates the rotation speed of the wheels.

6. The robot of claim 1, wherein the sensor unit comprises a cliff sensor, and
if the driving obstacle is a cliff existing in a lower area in front of the driving direction of the wheels, when the cliff sensor detects the presence of the cliff, the response motion comprises a motion that changes the rotation direction of the wheels to the opposite direction, and
before changing the rotation direction of the wheels, the arm is first rotated but the rotation direction of the arm is the driving direction of the robot.

7. The robot of claim 6, wherein the arm is rotated until a lower end of the arm is disposed at a lower front portion of the robot body.

8. A control method of a robot, as a control method performed for the robot driving on the ground using two wheels to pass an upper obstacle existing in front of the driving direction, comprising:
a sensing step in which a sensor unit of the robot detects the upper obstacle;
an arm rotation step in which an arm having an integrated structure coupled to left and right sides of a robot body of the robot is rotated to be positioned lower than an upper end of the robot body; and
a leg control step in which a coupling angle of a leg unit connecting the robot body and the wheels are controlled so that the robot body comes closer to the ground.

9. The control method of the robot of claim 8, wherein the arm rotation step rotates the arm in the opposite direction to the driving direction of the robot.

10. The control method of the robot of claim 8, wherein the sensing step measures a first height from the ground to a lower end of the upper obstacle by using the sensor unit, and
compares the first height with a second height which is the minimum height of the robot implemented through the control of the arm and the leg unit and determines passage or avoidance of the upper obstacle.

11. A control method of a robot, as a control method preformed for the robot driving on the ground using two wheels to avoid a cliff existing in front of the driving direction, comprising:
a first detection step in which a depth camera provided in the robot detects the cliff;
a first motion step in which an arm having an integrated structure coupled to left and right sides of a robot body of the robot rotates in the driving direction of wheels;
a second detection step in which a cliff sensor provided in the robot detects the cliff; and
a second motion step in which the rotation direction of the wheels is changed so that the robot drives in the opposite direction of the cliff.

12. The control method of the robot of claim 11, wherein the first motion step decelerates the rotation speed of the wheels when the distance to the cliff approaches a preset distance or less.

13. The control method of the robot of claim 11, wherein the first motion step disposes a lower end of the arm in a lower front portion of the robot body.
